(19) United States
(12) Patent Application Publication
(10) Pub. No.: US 2005/0210003 A1
(43) Pub. Date: Sep. 22, 2005

(54) Sequence based indexing and retrieval method for text documents

(76) Inventors: Yih-Kuen Tsay, Taipei (TW); Ching-Lin Yu, Taipei (TW); Yu-Fang Chen, Taipei (TW)

Correspondence Address: RAYMOND Y. CHAN, 108 N. YNEZ AVE., SUITE 128, MONTEREY PARK, CA, 91754, US

(21) Appl. No.: 10/803,478

(22) Filed: Mar. 17, 2004

(51) Int. Cl. G06F 7/00

(52) U.S. Cl. 707/3

(57) ABSTRACT

A sequence based indexing and retrieval method for a collection of text documents includes the steps of generating a query token sequence from a query; generating at least a representative token sequence from each of the documents that contain at least one token of the query token sequence; measuring a similarity between each of the representative token sequences and the query token sequence; and retrieving the text document in responsive to the similarity of the representative query token sequence with respect to the query token sequence. The similarity measurement is preformed by determining a token appearance score, a token order score, and a token consecutiveness score of the representative token sequence with respect to the query token sequence, so as to illustrate the similarity between the representative token sequence and the query token sequence for precisely and effectively retrieving the text document.

### BACKGROUND OF THE PRESENT INVENTION

1. Field of Invention

The present invention relates to a database search engine and, more particularly, to a sequence based indexing and retrieval method for a collection of text documents, which is adapted to produce a ranked list of the text documents relative to a user's query by matching representative token sequences of each document in the collection against the token sequence of the query.

2. Description of Related Arts

The main task of a text retrieval system is to help the user find, from a collection of text documents, those that are relevant to his query. The system usually creates an index for the text collection to accelerate the search process. Inverted indices (files) are a popular way for such indexing. For each token (word or character), the index records the identifier of every document containing the token. Some extension of inverted indices records not only which documents contain a particular token, but also the positions where in a document the token appears.

Traditional text retrieval models (such as the boolean model and the vector model) are only concerned with the existence of a token in the target document and are insensitive to token order or position. Given a query “United Nations,” a traditional retrieval system would consider a document with both “United” and “Nation” (after stemming) as equally relevant as a document that actually contains the phrase “United Nations.” One solution to this problem is to index phrases, which would considerably increase the size of the index and require the use of a dictionary. An alternative is for a retrieval system to utilize positional information. If the system takes positional information into account, a document that contains “United” and “Nations” in consecutive positions will be ranked higher than a document with both words in separate positions. The present invention exploits positional information to its fullest potential.

### SUMMARY OF THE PRESENT INVENTION

A main object of the present invention is to provide a sequence based indexing and retrieval method for a collection of text documents, which treats the documents and queries as sequences of token-position pairs and estimates the similarity between the document and query, so as to enhance the retrieval effectiveness while performing the query on the text documents.

Another object of the present invention is to provide a sequence based indexing and retrieval method for a collection of text documents, wherein the similarity measurement includes the token appearance, the token order, and the token consecutiveness, such that the approximate matching and fault-tolerant capability are substantially enhanced so as to precisely determine the similarity between the document and query.

Another object of the present invention is to provide a sequence based indexing and retrieval method for a collection of text documents, wherein the text document is pre-processed to select the candidate document therefrom to match with the query token sequence so as to enhance the speed of the retrieval process.

Another object of the present invention is to provide a sequence based indexing and retrieval method for a collection of text documents, wherein each of the text documents is indexed to measure a differentiating position of each two adjacent document tokens in the text document so as to enhance the process of matching the query token sequence with the document token sequence.

Another object of the present invention is to provide a sequence based indexing and retrieval method for a collection of text documents, which is specifically designed as a flexible and modular process that is easy to adjust, modify, and add modules or functionalities for further development.

Another object of the present invention is to provide a sequence based indexing and retrieval method for a collection of text documents, which is adapted to process the text document in Chinese, English, numbers, punctuations, and symbols, so as to enhance the practical use of the present invention.

Accordingly, in order to accomplish the above objects, the present invention provides a sequence based indexing and retrieval method for a text document, comprising the steps of:
(a) generating a query token sequence, having at least a query token, from a query submitted by a user;
(b) generating at least a representative token sequence, having at least a document token, from each of said text documents that contain at least one token of said query token sequence;
(c) measuring a similarity between said query token sequence and each of said representative token sequences; and
(d) retrieving said text documents in responsive to said similarity of said representative token sequence with respect to said query token sequence with a ranking order in accordance with a token appearance score, a token order score, and a token consecutiveness score, provided that for a document with two representative token sequences, its similarity is determined by the representative token sequence with a higher score.

The similarity measurement is preformed by determining a token appearance score, a token order score, and a token consecutiveness score of the representative token sequence with respect to the query token sequence. Therefore, the total score of the token appearance, the token order, and the token consecutiveness is determined as a similarity index to illustrate the similarity between the representative token sequence and the query token sequence, so as to precisely and effectively retrieve the text document.

These and other objectives, features, and advantages of the present invention will become apparent from the following detailed description, the accompanying drawings, and the appended claims.

### BRIEF DESCRIPTION OF THE DRAWINGS

FIG. 1 is a flow chart illustrating a sequence based indexing and retrieval method for a collection of text documents according to a preferred embodiment of the present invention.

### DETAILED DESCRIPTION OF THE PREFERRED EMBODIMENT

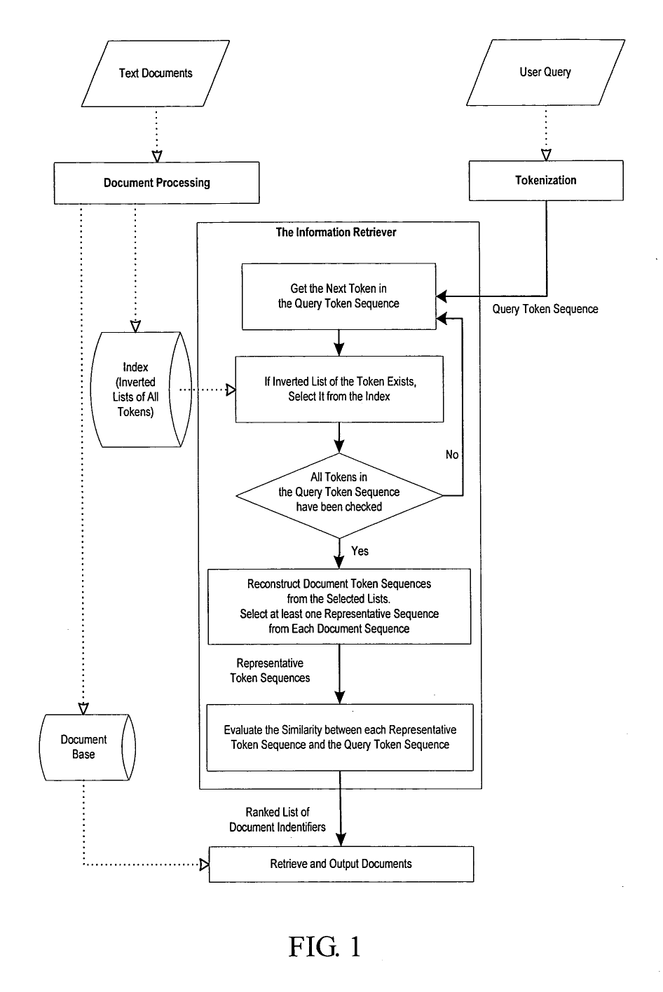

Referring to FIG. 1 of the drawings, a sequence based indexing and retrieval method for a text document according to a preferred embodiment of the present invention is illustrated, wherein the method comprises the following steps.

(1) Generate a query token sequence, having at least a query token, from a query submitted by a user.

(2) Generate at least a representative token sequence, having at least a document token, from each of said documents that contain at least one token of said query token sequence.

(3) Measure a similarity between each of the representative token sequences and the query token sequence.

(4) Retrieve the text documents in responsive to said similarity of said representative token sequence with respect to said query token sequence with a ranking order in accordance with a token appearance score, a token order score, and a token consecutiveness score, provided that for a document with two representative token sequences, its similarity is determined by the representative token sequence with a higher score.

In step (1), the query may contain both English and Chinese. A “Tokenizer” process is preformed to transform the query text into the query token sequence. The key of the Tokenizer is its data analysis component. The input data of the data analysis component is text which is represented as a byte array. This component processes the byte array elements one by one. When encountering the first byte of a Chinese character (in BIG5 encoding, the first byte of a Chinese character is range form ‘A4’ to ‘FF’), combine it with the next byte to construct a Chinese character. When encountering an English letter (‘41’ to ‘5A’ and ‘61’ to ‘7A’), the present invention will check the next byte continuously until reaching a non-English and non-hyphen byte. Then, all checked English letters are combined to construct an English word. If we encounter a non-English and non-Chinese byte (for example, numbers), the number will be treated as an independent unit.

After the data analysis component has parsed out a Chinese character, an English word or others, we use the information to construct a new token by its content, type, and position. After we have processed all bytes, a sequence of query tokens will be constructed.

It is worth mentioning that verb patterns vary in the rules of grammar of the English language, such as present tense, past tense, etc, such that the step (1) further comprises a step of stemming the query tokens to encode the text words into the corresponding word stems respectively by a stemmer. For example, the query token “connecting” is encoded to be “connect” as the origin word stem by removing the suffix thereof. However, for some languages, such as Chinese language, the stemming step can be omitted due to the rules of grammar of the language.

After the introduction of the Tokenizer component, we now explain our method. First, we have to build an index for the collection of text documents. For each token, we record not only which documents contain the token but also the positions where in a document the token appears. For example, the index of a token in essence can be expressed as an extended inverted list:
((D₁, (P₁, P₂, P₃, . . . )), (D₂, (P₁, P₂, P₃ . . . )) . . . )

According to the preferred embodiment, the step (2) further comprises a step of selecting at least a candidate document from the text documents, wherein one of the text documents is selected to be a candidate document when the respective text document contains the at least one token in the query token sequence.

If the query token sequence contains common words, such as “we,” the number of possible candidate documents will be large and thus will reduce the efficiency of the retrieval system. The solution is to adopt the “token weights” concept. The basic idea of this approach is to eliminate tokens with low discrimination power in the query token sequence. Before using this approach, we have to calculate token weights first. We use the inverse document frequency (idf) metric as token weights. With the weight of each token, we can decide a threshold to drop unimportant query tokens in candidate documents selection.

Here we introduce the approach we designed to solve this problem.

1. For a query token sequence, first we will find out the token with highest weight (Wₕ) and lowest weight (W₁.)

2. A cut-off percentage cp is given by an implementation parameter wherein cp is in the range of between 0 and 1.

3. Check each query token in the query token sequence. If a token's weight is lower than W₁+cp*(Wₕ−W₁), we determine that the query token is not as important as other query tokens, and does not use it to select candidate documents.

The document token sequence of the text document is obtained as follows: for each token in a query token sequence, the extended inverted list thereof is obtained from the index; and all lists are combined to construct the document token sequences.

After the document token sequence is chosen, we have to find its representative token sequences. A representative token sequence is a segment of the document token sequence. We divide a document token sequence into segments, wherein for each segment, the distance between two adjacent document tokens is no longer than a predetermined positioning value. Two longest segments of the document token sequence are selected as representative token sequences. Here we give an example:

The query token sequence: A₁B₂

The document: AXXBABXXXBAXXXBABABBXXXBA

The given threshold (predetermined positioning value): 3

After the division, we obtain the following four segments: A₁B₄A₅B₆, B₁₀A₁₁, B₁₅A₁₆B₁₇A₁₈B₁₉B₂₀, B₂₄A₂₅. The two longest segments i.e., A₁B₄A₅B₆ and B₁₅A₁₆B₁₇A₁₈B₁₉B₂₀, will be the represenative token sequences of this document.

To summarize, the two longest segments of the document token sequence are selected as represenative token sequences wherein the positional differntation of each adjacent document tokens is no larger than a predetermined positioning value while said corresponding text document is selected as the said candidate document.

The following example mainly illustrates the generation of represenative token sequence in form of Chinese language.

The text document is shown as:

Doc # 134

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

The query is input as [symbol] wherein the query is transformed into the query token sequence by a Tokenizer as [symbol] [symbol] while the indices of the relevant document tokens are shown as below:

Extended Inverted Lists:
[symbol] (Doc#134,(1, 41, 54, 65, 81)),(Doc#135, . . .
[symbol] (Doc#134,(45)),(Doc#135, . . .
[symbol] (Doc#134,(47)),(Doc#135, . . .

Reconstruction of the document token sequences (on the basis that the query token sequence is [symbol]
. . .
Doc#134 [symbol] [symbol] [symbol] [symbol]
Doc#135 . . .
. . .

With a given threshold (a predetermined positioning value) 3, the document token sequence [symbol] [symbol] [symbol] [symbol] of Doc#134 is formed into five segments which are [symbol] [symbol] [symbol] [symbol] [symbol] and [symbol] Accordingly, the two longest segments of the document token sequences [symbol] and [symbol] [symbol] [symbol] are selected in this example as representative token sequences for determining the similarity between the between the query token sequence and the document token sequence.

According to the preferred embodiment, the step (3) further comprises the following steps, wherein D=(dᵢ_{₁}, dᵢ_{₂}, . . . , dᵢ_{ⱼ}, . . . , dᵢ_{ₘ}) (of m tokens) and Q=(qᵢ_{₁}, qᵢ_{₂}, . . . qᵢ_{ⱼ}, . . . , qᵢ)(of n tokens) respectively denote the representative token sequence and the query token sequence under similarity measurement.

(3.1) Determine a token appearance (TA) score by measuring a token appearance of the query representative token sequence with respect to the query token sequence.

(3.2) Determine a token order (TO) score by measuring a token order of the representative token sequence with respect to the query token sequence.

(3.3) Determine a token consecutiveness (TC) score by measuring a token consecutiveness of the representative token sequence with respect to the query token sequence.

The step (3.1) comprises the following sub-steps.

(3.1.1) Consult an index of said text documents to determine the weight of each token in the query token sequence.

(3.1.2) Calculate a sum of the weights of the query tokens that appear in the representative token sequence.

(3.1.3) Output a token appearance score of the token appearance by calculating the fraction of the sum divided by the total weight of all query tokens.

As mentioned above, the weight of a query token is measured by (idf+1). Accordingly, the following equation illustrates the determination of the token appearance TA.

Token Appearance (TA):

$$TA ( D , Q ) = \frac{{\sum }_{j = 1}^{n} t ( {q}_{{i}_{j}} ) \times w ( {q}_{{i}_{j}} )}{{\sum }_{j = 1}^{n} w ( {q}_{{i}_{j}} )} ,$$

wherein w(qᵢ_{ⱼ}) represents the weight of the “jₜₕ” query token.

Accordingly, t(qᵢ_{ⱼ})=1 if the “jₜₕ” query token is shown in the representative token sequence and t(qᵢ_{ⱼ})=0 if the “jₜₕ” query token is not shown in the representative token sequence.

The object of the token order (TO) measurement is to capture the word/character ordering, wherein the step (3.2) comprises the following sub-steps.

(3.2.1) Determine a length of the longest common subsequence of the representative token sequence and the query token sequence;

(3.2.2) Determine a length of the representative token sequence;

(3.2.3) Determine a length of the query token sequence; and

(3.2.4) Output the token order score of said token order by calculating a fraction of the length of the longest common subsequence divided by an average sum of the length of the representative token sequence and the length of the query token sequence.

Accordingly, the equation for the token order TO is:
Token Ordering (TO):

$$TO ( D , Q ) = \frac{\vert LCS ( D , Q ) \vert}{( \vert D \vert + \vert Q \vert ) \div 2} ,$$

where LCS(D,Q) is the longest common subsequence of D and Q and |S| denotes the length of sequence S.

The object of the token consecutiveness (TC) measurement is to capture the distribution of the query tokens, wherein the step (3.3) further comprises the following sub-steps.

(3.3.1) Determine a relative distance between a positional differentiation of each adjacent document tokens and a positional differentiation of said adjacent document tokens in the query token sequence.

(3.3.2) Output the token consecutiveness score of the token consecutiveness by calculating a fraction of a sum of the inverses of the relative distances divided by the number of pairs of adjacent tokens, which equals the length of the representative token sequence less one.
Token Consecutiveness (TC):

$$TC ( D , Q ) = \frac{{\sum }_{j = 1}^{m - 1} \frac{1}{r {d}_{j}}}{m - 1} ,$$

where rdⱼ=|(iⱼ_{₊ᵢ}−iⱼ)−(pos(dᵢ_{ⱼ₊₁}, Q)−pos(dᵢ_{ⱼ}, Q))|+1 where pos(tₖ, Q) gives the position of t in Q. When there are more than one possible values for pos(d₁_{ⱼ₊₁}, Q) or pos(dᵢ_{ⱼ}, Q), the values may be chosen such that |(iⱼ_{₊₁}−iⱼ)−(pos(dᵢ_{ⱼ₊₁}, Q)−pos(dᵢ_{ⱼ}, Q))| is as small as possible.

The above three measures all have a score ranging from 0 to 1. A linear combination (weighted sum) of the measures (which also ranges from 0 to 1) can be calculated from α₁TA(D,Q)+α₂TO(D,Q)+α₃ TC(D,Q) with a suitable selection of α₁, α₂, and α₃ such that α₁+α₂+α₃=1. An implementation may allow the user to select the coefficients.

Therefore, the similarity of the query token sequence is calculated by summing the token appearance score, the token order score, and the token consecutiveness score.

The result shown below illustrates the determination of the similarity between the representative token sequence and the query token sequence.

Following the earlier example, we consider measuring the similarity between the representative token sequence [symbol] [symbol] [symbol] and the query token sequence

[symbol]

[symbol]

Token appearance TA of the query token sequence:
TA=(1*(⅓)+1*(⅓)+1*(⅓))/(⅓+⅓+⅓)=1

Token order TO of the query token sequence: TO=3/((3+3)/2)=1

Token consecutiveness TC of the query token sequence: d₁=1+|(45−41)−(2−1)|=4; d₂=1+|(47−45)−(3−2)|=2; TC=((¼)+(½)/2=0.375

The similarity: 1*⅓+1*⅓+1*0.375=0.792

The following experimental results illustrate the accuracy of the search result by using the present invention in comparison with the bigram method.

Experiment 1 illustrates the query including a person name and the prefix thereof.

Query [symbol] [symbol] wherein [symbol] is the name of a person and [symbol] is a prefix of the person.

| | The present | | | |
|---|---|---|---|---|
| | invention | | Bigram method | |
| Text Documents | Point value | Ranking | Point value | Ranking |
| [symbol] | 1.0 | 1 | 1.0 | 1 |
| [symbol] | 0.861 | 2 | 0.5 | 2 |
| [symbol] | 0.808 | 3 | 0.5 | 2 |
| [symbol] | 0.804 | 4 | 0.5 | 2 |
| [symbol] | 0.654 | 5 | 0.25 | 5 |
| [symbol] | 0.616 | 6 | 0.25 | 5 |

Experiment 2 illustrates the query including two person names and a connecting word therebetween.

Query: [symbol] [symbol] wherein [symbol] and [symbol] are the names of the person and [symbol] is the connecting word for [symbol] and

[symbol]

| | The present | | | |
|---|---|---|---|---|
| | invention | | | |
| | Point | | Bigram method | |
| Text Documents | value | Ranking | Point value | Ranking |
| [symbol] | 1.0 | 1 | 1.0 | 1 |
| [symbol] | 0.968 | 2 | 0.833 | 2 |
| [symbol] | 0.903 | 3 | 0.667 | 3 |
| [symbol] | 0.79 | 4 | 0.667 | 3 |
| [symbol] | 0.787 | 5 | 0.667 | 3 |
| [symbol] | 0.76 | 6 | 0.667 | 3 |
| [symbol] | 0.614 | 7 | 0.333 | 7 |
| [symbol] | 0.614 | 7 | 0.333 | 7 |
| [symbol] | 0.33 | 9 | 0 | 9 |

Experiment 3 illustrates the query including the abbreviation of a noun phrase.

| | | Point Value | |
|---|---|---|---|
| | | The | |
| | | Present | Bigram |
| Query | Text Documents | Invention | Method |
| [symbol] | [symbol] | 0.95 | 0.6 |
| [symbol] | [symbol] | 0.789 | 0.249 |
| [symbol] | [symbol] | 0.875 | 0 |
| [symbol] | [symbol] | 0.541 | 0 |
| [symbol] | [symbol] | 0.844 | 0 |
| [symbol] | [symbol] | 0.458 | 0 |
| [symbol] | [symbol] | 0.844 | 0 |
| [symbol] | [symbol] | 0.458 | 0 |
| [symbol] | [symbol] | 0.875 | 0.333 |
| [symbol] | [symbol] | 0.468 | 0.111 |

Therefore, the approximate matching and fault-tolerant capabilities are substantially enhanced so as to efficiently and precisely retrieve text documents with respect to the query submitted by the user.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1. A sequence based indexing and retrieval method for text documents, comprising the steps of:
(a) generating a query token sequence, having at least a query token, from a query submitted by a user;
(b) generating at least a representative token sequence, having at least a document token, from each of said text documents that contain at least one token of said query token sequence;
(c) measuring a similarity between each of said representative token sequences and said query token sequence by:
(c.1) determining a token appearance score by measuring a token appearance of said representative token sequence with respect to said query token sequence;
(c.2) determining a token order score by measuring a token order of said representative token sequence with respect to said query token sequence; and
(c.3) determining a token consecutiveness score by measuring a token consecutiveness of said representative token sequence with respect to said query token sequence; and
(d) retrieving said text documents in responsive to said similarity of said representative token sequence with respect to said query token sequence with a ranking order in accordance with said token appearance score, said token order score, and said token consecutiveness score, provided that for a document with two representative token sequences, its similarity is determined by the representative token sequence with a higher score.

2. The method, as recited in claim 1, wherein the step (c.1) comprises the sub-steps of:
(c.1.1) consulting an index of said text documents to determine the weight of each token in said query token sequence;
(c.1.2) calculating a sum of the weights of the query tokens that appear in said representative token sequence; and
(c.1.3) outputting said token appearance score of said token appearance by calculating a fraction of said sum divided by the total weight of all query tokens.

3. The method, as recited in claim 2, wherein said weight of said query token in said query token sequence is measured by determining a token frequency of said query token in said text documents.

4. The method, as recited in claim 1, wherein the step (c.2) comprises the sub-steps of:
(c.2. 1) determining a length of the longest common subsequence of said representative token sequence and said query token sequence;
(c.2.2) determining a length of said representative token sequence;
(c.2.3) determining a length of said query token sequence; and
(c.2.4) outputting said token order score of said token order by calculating a fraction of said length of said longest common subsequence divided by an average sum of said length of said representative token sequence and said length of said query token sequence.

5. The method, as recited in claim 3, wherein the step (c.2) comprises the sub-steps of:
(c.2.1) determining a length of the longest common subsequence of said representative token sequence and said query token sequence;
(c.2.2) determining a length of said representative token sequence;
(c.2.3) determining a length of said query token sequence; and
(c.2.4) outputting said token order score of said token order by calculating a fraction of said length of said longest common subsequence divided by an average sum of said length of said representative token sequence and said length of said query token sequence.

6. The method, as recited in claim 1, wherein the step (c.3) comprises the sub-steps of:
(c.3.1) determining a relative distance between a positional differentiation of each adjacent document tokens and a positional differentiation of said adjacent document tokens in said query token sequence; and
(c.3.2) outputting said token consecutiveness score of said token consecutiveness by calculating a fraction of a sum of the inverses of said relative distances divided by the number of pairs of adjacent tokens, which equals the length of said representative token sequence less one.

7. The method, as recited in claim 3, wherein the step (c.3) comprises the sub-steps of:
(c.3.1) determining a relative distance between a positional differentiation of each adjacent document tokens and a positional differentiation of said adjacent document tokens in said query token sequence; and
(c.3.2) outputting said token consecutiveness score of said token consecutiveness by calculating a fraction of a sum of the inverses of said relative distances divided by the number of pairs of adjacent tokens, which equals the length of said representative token sequence less one.

8. The method, as recited in claim 5, wherein the step (c.3) comprises the sub-steps of:
(c.3.1) determining a relative distance between a positional differentiation of each adjacent document tokens and a positional differentiation of said adjacent document tokens in said query token sequence; and
(c.3.2) outputting said token consecutiveness score of said token consecutiveness by calculating a sum of the inverses of said relative distances with respect to said representative token sequence.

9. The method, as recited in claim 8, wherein said similarity of said representative token sequence is calculated with respect to said query token sequence by summing said token appearance score, said token order score, and said token consecutiveness score, wherein said ranking order of said text documents is determined by a weighted sum of said token appearance score, said token order score, and said token consecutiveness score of each of said representative token sequences of said text documents.

10. The method as recited in claim 1, in step (b), further comprising a step of selecting at least a candidate document from said text documents, wherein one of said text documents is selected to be said candidate document when said text document contains at least one token of said query token sequence.

11. The method as recited in claim 9, in step (b), further comprising a step of selecting at least a candidate document from said text documents, wherein one of said text documents is selected to be said candidate document when said text document contains at least one token of said query token sequence.

12. The method as recited in claim 10, in step (b), further comprising a step of consulting an index of said text documents to establish said candidate document, wherein tokens that also appear in the query token sequence are collected to form a document token sequence for each document and the two longest segments of said document token sequence are selected as representative token sequences wherein the positional differentiation of each adjacent document tokens is no larger than a predetermined positioning value while said corresponding text document is selected as the said candidate document.

13. The method as recited in claim 11, in step (b), further comprising a step of consulting an index of said text documents to establish said candidate document, wherein tokens that also appear in the query token sequence are collected to form a document token sequence for each document and the two longest segments of said document token sequence are selected as representative token sequences wherein the positional differentiation of each adjacent document tokens is no larger than a predetermined positioning value while said corresponding text document is selected as the said candidate document.

14. The method as recited in claim 10, in step (b), further comprising a step of retaining said candidate document to be used for measuring said similarity with respect to said query token sequence, wherein the said candidate document is retained when said candidate document contains a token that has a weight no less than a predetermined fraction of the total weight of query tokens.

15. The method as recited in claim 11, in step (b), further comprising a step of retaining said candidate document to be used for measuring said similarity with respect to said query token sequence, wherein the said candidate document is retained when said candidate document contains a token that has a weight no less than a predetermined fraction of the total weight of query tokens.

16. The method as recited in claim 13, in step (b), further comprising a step of retaining said candidate document to be used for measuring said similarity with respect to said query token sequence, wherein the said candidate document is retained when said candidate document contains a token that has a weight no less than a predetermined fraction of the total weight of query tokens.

17. The method, as recited in claim 1, wherein said text document contains Chinese characters, English words, numbers, punctuations, and symbols as said document tokens.

18. The method, as recited in claim 9, wherein said text document contains Chinese characters, English words, numbers, punctuations, and symbols as said document tokens.

19. The method, as recited in claim 13, wherein said text document contains Chinese characters, English words, numbers, punctuations, and symbols as said document tokens.

20. The method, as recited in claim 16, wherein said text document contains Chinese characters, English words, numbers, punctuations, and symbols as said document tokens.
